(19) United States
(12) Patent Application Publication
(10) Pub. No.: US 2003/0026642 A1
(43) Pub. Date: Feb. 6, 2003

(54) Air passing coating instrument cap

(76) Inventor: Gilbert Schwartzman, Mamaroneck, NY (US)

Correspondence Address: Clyde I. Coughenour, 16607 Sutton Place, Woodbridge, VA, 22191, US

(21) Appl. No.: 09/919,855

(22) Filed: Aug. 2, 2001

(51) Int. Cl. B43K 23/12

(52) U.S. Cl. 401/243

(57) ABSTRACT

A writing instrument cap has a tubular lower section, a tapered intermediate section, and a domed upper section. The domed upper section includes a dome, that provides a pocket for a writing or coating means, and a platform, for supporting the dome and providing a sealing surface for an applicator. The tubular lower section provides for attachment to a container. The intermediate tapered section connects the dome section to the tubular section and is provided with plural openings or slots for air passage through the lower section and around and past the dome section.

### BACKGROUND OF THE INVENTION

1. Field of the Invention

A coating container cap is provided with air passages to reduce the possibility of suffocation if swallowed.

2. Description of Related Art

The problem of asphyxiation due to swallowing small objects, such as container bottle caps, is not uncommon. To reduce the possibilities of asphyxiation, various schemes have been devised to provide air passages through such caps.

The basic approach to providing air passages in caps includes both isolating the writing or marking means, such as to preclude evaporation, and permitting air to freely engage the writing or marking means for ventilation. J. A. Skilton, (U.S. Pat. No. 682,574 issued Sep. 10, 1901) and D. Greenspan (U.S. Pat. No. 4,459,059 issued Jul. 10, 1984) and Japan 2-22887 of Feb. 15, 1990, are examples of a cap that removed provides an air flow path and while positioned over the writing or marking means also permits air flow to the writing or marking means.

Nagel et al (U.S. Pat. No. 4,969,766 issued Nov. 13, 1990) and Petrillo et al (U.S. Pat. No. 5,066,156, issued Nov. 19, 1991) and H. Melnick (U.S. Pat. No. 5,590,971, issued Jan. 7, 1997) represent a group of patents that enclose a tip sealing inner member within an outer shell or member with air passages between the two.

D. Belmondo (U.S. Pat. No. 5,073,056, issued Dec. 17, 1991 and U.S. Pat. No. 5,076,721, issued Dec. 31, 1991) and W. Quante (German, DE 8,906,686 of May 29, 1989) represent a group of patents wherein an outer cap shell is provided with outwardly and upwardly extending fins that hold in place an inner sealing member and provide an air passage past the inner sealing member.

### SUMMARY OF THE INVENTION

The present invention simplifies caps and their manufacture by accomplishing both sealing the writing or marking means, with an enclosure when attached, and providing air flow through when not attached. This is accomplished without the use of an outer shell or extension of or from an outer shell. An upper dome or chamber is supported on a platform forming an upper section that is attached to a lower tubular section by a tapered intermediate section. The lower tubular section can be attached to a fluid container having a discharge means such as a nib. When the cap is attached to the fluid container, a sealing surface on the container contacts a sealing surface on the inside surface of the platform to isolate the nib within a cavity or pocket within the dome. The cap performs its function with essentially no extension in the length of the coating or writing implement. The tapered intermediate section is provided with openings or slots to maintain an air passage through the cap when it is removed from the container. The angle of the intermediate tapered section and multiplicity of openings around the cap provide for air passage in the event the cap is swallowed.

### BRIEF DESCRIPTION OF THE DRAWINGS

FIG. 1 is an exploded view of a coating implement container with an air passing cap of the invention.

FIG. 2 is a top view of the cap shown in FIG. 1.

FIG. 3 is a cross-sectional view of the cap shown in FIG. 1 along the section lines 3-3.

### DESCRIPTION OF THE PREFERRED EMBODIMENTS

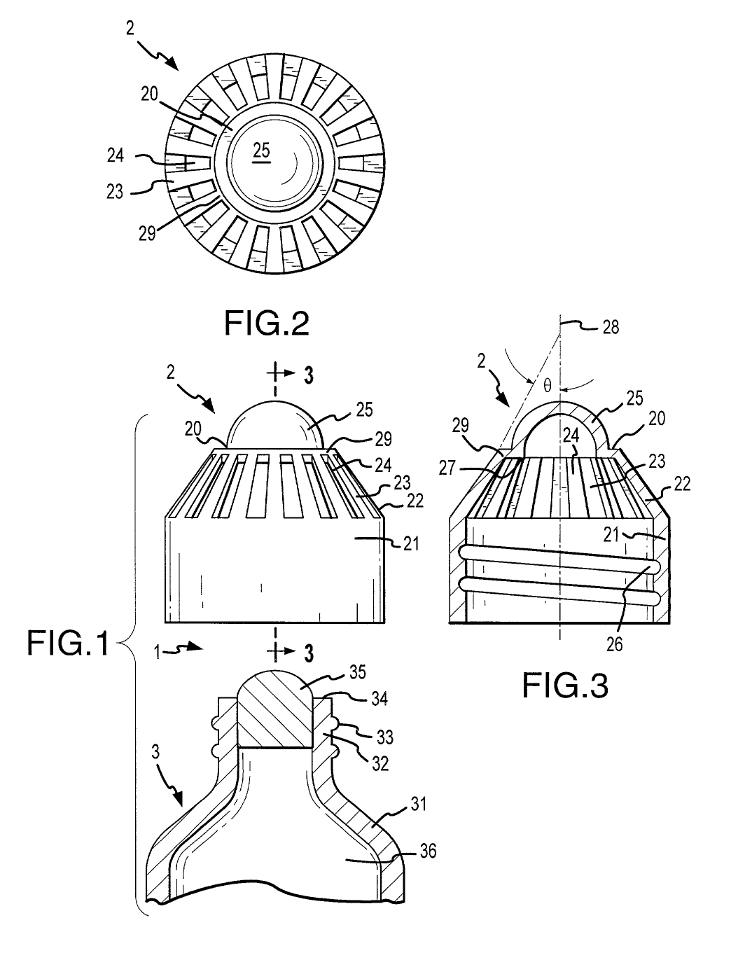

FIG. 1 is an exploded view showing an applicator 1 with the cap 2 of the invention shown from the side and container 3 shown in relief cross-section.

The cap 2 is shown from the top in FIG. 2 and in cross-section in FIG. 3, along the section lines 3-3 of FIG. 1. The container 3 houses fluid within the container chamber 36 of the fluid receptacle 31. The neck 32 of the container secures porous fluid application means, shown as a nib 35.

A preferably molded integrally formed cap 2 includes a lower tubular section 21 and an upper dome section 20. The lower tubular section is connected to the upper dome section by a tapered intermediate section 22. The lower tubular section 21 is shown with a female thread inner bore 26. The female threads 26 of the inner bore engage with the male threads 33 of the container neck 32 to secure the cap on the container. The upper dome section 20 is shown with a dome 25 positioned on a platform 29. To sealingly secure the nib 35 within the dome 25 cavity, the lower inner extent of the dome platform 29 has a sealing surface 27 that engages with the upper container neck sealing surface 34. The container sealing surface 34 contacts the cap sealing surface 27, preferably closer to the center line 28 of the cap 2 then to the inward extent of the intermediate tapered section 22 air slots 24 and spacer strips 23. This isolates the nib 35 within the dome 25 cavity when the cap is placed on the container to prevent evaporation of fluid from the nib.

The tapered intermediate section 22 of the cap 2 slopes inwardly from the top of the lower tubular section 21 to the dome section platform 29. The tapered intermediate section is provided around its entire periphery with air passage openings or slots 24 spaced by intermediate spacer strips 23. The lower tubular section 21 is securely fastened to the dome section by the spacer strips 23 of the tapered intermediate section 22.

The cap can be a one piece injection molded product. The cap has an essentially constant thickness throughout with the only possible or necessary deviation being the lower tubular section threaded area. The cap is easily removable and adds little to the width and height of the container while sealing the container nib or coating implement from evaporation when attached, yet provides a good air flow-through area in the event it is swallowed. The wall thickness is generally less than 3/16 inch and preferably ⅛ inch or less, especially above the lower tubular section. The taper of the intermediate section forms an angle θ that is preferably from 20° to 50° with respect to the cap center line 28. The taper requires both a lateral and longitudinal obstruction to block air flow. It is difficult to prevent air flow from any angle without the need for additional protrusions or obstructions. For a firm and effective sealing with good air flow-through, the intermediate section taper is provided with an open air flow area that occupies from 40 to 60 percent of the total intermediate section tapered area. The distance between the sealing surface 27 and top of the dome 25 is generally less than ½ inch and preferably less than ¼ inch. The total height of the cap from the base of the lower tubular section to the top of the dome is less than ½ inch and preferably less than one inch. The addition in length of the applicator with the cap on is less than ½ inch and preferably less than ¼ inch. The cap of the invention performs the attachment sealing and air flow through function with simplicity, minimal material and only a minor protrusion

It is believed that the construction, operation and advantages of this invention will be apparent to those skilled in the art. It is to be understood that the present disclosure is illustrative only and that changes, variations, substitutions, modifications and equivalents will be readily apparent to one skilled in the art and that such may be made without departing from the spirit of the invention as defined by the following claims.

1. An applicator cap comprising:
a lower tubular section for attachment to a container;
an upper dome section for housing a porous fluid applicator means;
said upper dome section having a dome closure on a platform;
an intermediate tapered section extending between said lower tubular section and said platform of said upper dome section for securing said lower tubular section and said upper dome section together;
said intermediate tapered section having openings therethrough to provide for air passage through said lower tubular section and around and past said dome section.

2. An applicator cap as in claim 1 wherein:
said intermediate tapered section has an upper end and a lower end with said upper end having a diameter that is smaller at said upper end, where it attaches to said dome section, than its diameter at its said lower end where it attaches to said lower tubular section.

3. An applicator cap as in claim 1 wherein:
said upper dome section has a smaller diameter than the diameter of said lower tubular section;
said intermediate tapered section has an upper end and a lower end with a diameter that is greater at said lower end, where it attaches to said tubular lower section, than it has at its said upper end, where it attaches to said upper dome section.

4. An applicator cap as in claim 1 wherein:
said upper dome section platform has an aperture therein communicating with a pocket provided within said dome on said platform;
said dome section platform has upper and lower surfaces with said dome section platform lower surface having an inner and an outer extension.

5. An applicator cap as in claim 4 wherein:
said dome section platform lower surface outer extension is attached to an upper end of said intermediate tapered section.

6. An applicator cap as in claim 5 wherein:
said dome section platform lower surface inner extension forms a sealing surface.

7. An applicator cap as in claim 6 wherein:
said container has a neck;
said porous fluid applicator means is fixed within said container neck;
said container neck has an upper surface that is provided with a sealing means;
said dome section platform lower surface inner extension sealing surface engages said container neck sealing means to isolate said porous fluid applicator means within said upper dome section pocket.

8. An applicator cap as in claim 7 wherein:
said applicator cap is less than 1 inch high and increases the length of the applicator by less than ¼ inch when attached.

9. An applicator cap as in claim 8 wherein:
said tapered intermediate section has a taper of from 20° to 50° with respect to the centerline of said applicator cap;
said tapered intermediate section has an open airflow area that occupies from 40 to 60 percent of the total intermediate section area.

10. An applicator cap as in claim 1 wherein:
said lower tubular section and said upper dome section and said intermediate tapered section are formed as one continuous integral part.

11. An applicator cap as in claim 10 wherein:
said intermediate tapered section has an upper end and a lower end with said upper end having a diameter that is smaller, where it attaches to said dome section, than its diameter at its said lower end, where it attaches to said lower tubular section.
said upper dome section has a smaller diameter than the diameter of said lower tubular section.

12. An applicator cap as in claim 10 wherein:
said upper dome section platform has an aperture therein communicating with a pocket provided within said dome on said platform;
said dome section platform has upper and lower surfaces with said dome section platform lower surface having an inner and an outer extension.

13. An applicator cap as in claim 1 wherein:
said lower tubular section and said upper dome section and said upper dome of said applicator cap all have essentially the same thickness.

14. An applicator cap as in claim 13 wherein:
said upper dome section and said intermediate dome section thickness are less than ⅛ inch.

15. An applicator cap as in claim 1 wherein:
said applicator cap is less than ½ inch high and increases the length of the applicator by less than ¼ inch when attached.

16. An applicator cap as in claim 15 wherein:
said tapered intermediate section has a taper of from 20° to 50° with respect to the centerline of said applicator cap;
said tapered intermediate section has an open airflow area that occupies from 40 to 60 percent of the total intermediate section surface area.

17. An applicator cap as in claim 1 wherein:
said tapered intermediate section has a taper of from 20° to 50° with respect to the centerline of said applicator cap.

18. An applicator cap as in claim 1 wherein:
said tapered intermediate section has an open airflow area that occupies from 40 to 60 percent of the total intermediate section surface area.
